(19) United States
(12) Patent Application Publication
(10) Pub. No.: US 2009/0323971 A1
(43) Pub. Date: Dec. 31, 2009

(54) Protecting independent vendor encryption keys with a common primary encryption key

(76) Inventors: Peter R. Munguia, Chandler, AZ (US); Steve J. Brown, Phoenix, AZ (US); Dhiraj U. Bhatt, Portland, OR (US); Dmitrii Loukianov, Chandler, AZ (US)

Correspondence Address: INTEL CORPORATION;c/o CPA Global, P.O. BOX 52050, MINNEAPOLIS, MN, 55402, US

(21) Appl. No.: 11/648,339

(22) Filed: Dec. 28, 2006

(51) Int. Cl. H04L 9/08; H04L 9/00; H04L 9/14

(52) U.S. Cl. 380/284; 380/277

(57) ABSTRACT

Apparatus, systems and methods for protection of independent vendor encryption keys with a common primary encryption key are disclosed including an apparatus including memory to store a plurality of encrypted vendor keys, memory to store a primary key; and cipher logic to use the primary key to decrypt an encrypted vendor key of the plurality of encrypted vendor keys to provide an effective key. Other implementations are disclosed.

### CROSS-REFERENCE TO RELATED APPLICATIONS

The present application is related to application Ser. No. 11/400,766, entitled “Method And Apparatus To Mate An External Code Image With An On-Chip Private Key” and filed Apr. 6, 2006 (Docket No. P24003); to application Ser. No. 11/399,712, entitled “Supporting Multiple Key Ladders Using A Common Private Key Set” and filed Apr. 6, 2006 (Docket No. P24004); and to application Ser. No. 11/399,714, entitled “Control Word Key Store For Multiple Data Streams” filed Apr. 6, 2006 (Docket No. P24006).

### BACKGROUND

Computing platforms often use “key ladders” to provide multiple layers of encryption security. A typical key ladder comprises a hierarchical set of encryption keys that are delivered to and processed securely within the computing platform and uses a primary encryption key as the “root of trust” to protect the first tier of the hierarchy. For example, a standard Set-Top Box (STB) computing platform may employ an embedded key ladder having in its first tier one encryption key provided by the manufacturer of the integrated circuits (ICs) used in the STB and another encryption key provided by the conditional access (CA) vendor who delivers consumer content to the STB. Hence, such a key ladder has two “roots of trust”: one originating with the silicon manufacturer and the other with the single CA vendor.

However, implementation of a standard key ladder has several drawbacks. For instance, incorporation of the CA vendor's key into the silicon manufacturer's production and/or validation process may present a security risk in its own right, may slow down the manufacturing process and may require the manufacturer to maintain multiple computing platform product lines each incorporating a different CA vendor's key. In addition, a traditional key ladder may not provide for revocation and/or updating of a CA vendor's key.

### BRIEF DESCRIPTION OF THE DRAWINGS

The accompanying drawings, incorporated in and constituting a part of this specification, illustrate one or more implementations consistent with the principles of the invention and, together with the description of the invention, explain such implementations. The drawings, which should not be taken to limit the invention to the specific implementations shown therein, are also not necessarily to scale nor should they be considered exhaustive, the emphasis instead being placed upon illustrating the principles of the invention. In the drawings,

FIG. 1 is a block diagram illustrating a device in accordance with some implementations of the invention;

FIGS. 2A and 2B show a flow chart illustrating a process in accordance with some implementations of the invention;

FIG. 3 is a block diagram illustrating a system in accordance with some implementations of the invention; and

FIG. 4 is a block diagram illustrating another system in accordance with some implementations of the invention.

### DETAILED DESCRIPTION

The following description refers to the accompanying drawings. Among the various drawings the same reference numbers may be used to identify the same or similar elements. While the following description provides a thorough understanding of the various aspects of the claimed invention by setting forth specific details such as particular structures, architectures, interfaces, techniques, etc., such details are provided for purposes of explanation and should not be viewed as limiting. Moreover, those of skill in the art will, in light of the present disclosure, appreciate that various aspects of the invention claimed may be practiced in other examples or implementations that depart from these specific details. At certain junctures in the following disclosure descriptions of well known devices, circuits, and methods have been omitted to avoid clouding the description of the present invention with unnecessary detail.

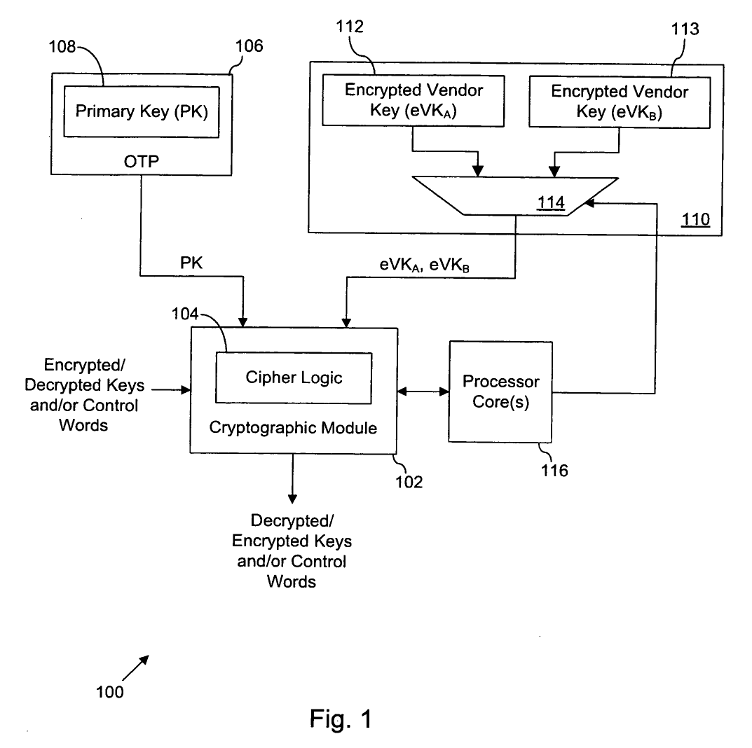

FIG. 1 illustrates a device 100 in accordance with some implementations of the invention. Device 100 includes a cryptographic module (CM) 102 including cipher logic (CL) 104, a one-time-programmable (OTP) memory 106 coupled to CM 102 and storing at least one primary encryption key (PK) 108, such as a common silicon manufacturer's encryption key, and processor core(s) 116 coupled to CM 102. Device 100 also includes memory 110 coupled to CM 102 and storing at least two independent encrypted vendor encryption keys (eVK_{A}) 112 and (eVK_{B}) 113 that may be selectively provided to CM 102 via a selection mechanism (e.g., a multiplexer) 114. Device 100 may comprise any apparatus and/or system suitable for the cryptographic processing (i.e., encrypting and decrypting) of encryption keys and/or data and/or software instructions in accordance with implementations of the invention as will be described in greater detail below.

Although the invention is not limited in this regard, each pair of encryption keys corresponding to the primary key PK 108 and one of the unencrypted forms of either encrypted vendor eVK_{A} 112 or eVK_{B} 113 may comprise asymmetric encryption key pairs. The functionality of asymmetric key pairs and their use in encryption/decryption processes is well known in the art and as such will not be discussed in any greater detail herein. In addition, while device 100 as illustrated includes only two encrypted vendor keys eVK_{A} 112 and eVK_{B} 113 the invention is not limited to two encrypted vendor keys and, thus, devices or systems in accordance with some implementations of the invention may include encrypted versions of three or more independent vendor encryption keys that may be selectively provided to a CM such as CM 102. The terms “key” and “encryption key” will be used interchangeably throughout this detailed description as well as in the claims that follow.

Device 100 may assume a variety of physical implementations. While all components of device 100 may be implemented within a single device, such as a system-on-a-chip (SOC) integrated circuit (IC), components of device 100 may also be distributed across multiple ICs or devices. Moreover, processor core(s) 116 may comprise any special purpose or a general purpose processor core(s) including any control and/or processing logic, hardware, software and/or firmware, capable of protecting independent vendor encryption keys with a common primary encryption key in accordance with implementations of the invention as will be explained in greater detail below.

CM 102 may include any processing logic in the form of hardware, software, and/or firmware, capable of protecting independent vendor encryption keys with a common primary encryption key in accordance with some implementations of the invention as will be explained in greater detail below. CM 102 may receive primary key PK 108 from OTP memory 106. In addition, CM 102 may, in accordance with some implementations of the invention, receive one of encrypted vendor keys eVK_{A} 112 or eVK_{B} 113 from memory 110 where that encrypted vendor key is provided to CM 102 in response to a selection signal supplied to mechanism 114 by, for example, processor cores 116.

CM 102 may then, in accordance with some implementations of the invention, implement a key ladder scheme by using CL 104 in conjunction with primary key PK 108 to decrypt either one of encrypted vendor keys eVK_{A} 112 or eVK_{B} 113 and then use the resulting unencrypted vendor key to decrypt other encrypted keys (such as encrypted control keys) as will be explained in greater detail below. CM 102 may undertake encryption and decryption tasks using CL 104 in response to commands issued by processor core(s) 116. CL 104 may include any processing logic in the form of hardware, software, and/or firmware, capable of undertaking or performing encryption/decryption processes.

The invention is not limited to a particular type of cryptographic process implemented by CM 102 and/or CL 104. Thus, for example, those skilled in the art will recognize that the primary key PK 108 and encrypted vendor keys eVK_{A} 112 or eVK_{B} 113 associated with device 100 may be dependent on the type of encryption process used by CL 104 to decrypt or encrypt keys and/or information (e.g., control words, text, etc). In some implementations of the invention, keys associated with device 100 may be consistent with well known asymmetric key schemes. Thus, for example, keys associated with device 100 may be keys consistent with well known cryptographic schemes such as the Public Key Infrastructure (PKI) scheme. In other words, keys associated with device 100 may be keys derived from and/or consistent with the well known Rivest, Shamir, and Adelman (RSA) digital signature algorithm (DSA). However, the invention is not limited in this regard and, thus, encryption keys associated with device 100 may be random unique keys, to name another possibility.

Memory 110 holding and/or storing encrypted vendor keys eVK_{A} 112 and eVK_{B} 113 may comprise non-volatile memory such as flash memory. For example, memory 110 may be a fixed non-volatile memory device (e.g., flash memory, hard disk drive, etc.), or a removable non-volatile memory device (e.g., a memory card containing flash memory, etc.) to name several examples. Further, memory 110 may be off-chip memory that is formed in a semiconductor substrate other than the semiconductor substrate incorporating CM 102 and/or processor core(s) 116. Alternatively, memory 110 may be incorporated into the same semiconductor substrate as that incorporating CM 102 and/or processor core(s) 116. The inverition is not, however, limited to using non-volatile memory to store vendor encryption keys encrypted or otherwise. Thus, for example, memory 110 may be volatile memory such as static random access memory (SRAM) or dynamic random access memory (DRAM) to name a few alternative examples.

Further, memory 110 may be any storage mechanism that is accessible by, for example, a vendor of a system such as a set-top box (STB) that includes device 100. Thus, in accordance with some implementations of the invention, a vendor (such as a conditional access (CA) vendor) of a computing platform employing device 100 who has knowledge of the primary root of trust (i.e., primary key PK 108) may access one or more of the vendor encryption keys stored in memory 110 in order to modify, replace and/or revoke that key. Moreover, in accordance with some implementations of the invention, a manufacturer of a computing platform employing device 100 (e.g., a manufacturer of a STB employing device 100) and who also has knowledge of the primary root of trust (i.e., primary key PK 108) may access one or more of the vendor encryption keys stored in memory 110 in order to modify, replace and/or revoke that key.

In addition, in accordance with some implementations of the invention, a manufacturer of device 100 (e.g., a manufacturer of ICs used in device 100) may provide a primary encryption key associated with device 100 (e.g., that manufacturer may provide or “program” OTP 106 with PK 108) which becomes the primary ‘root of trust’ for the system. Moreover, in accordance with some implementations of the invention, a manufacturer of a computing platform (such as a STB) employing device 100 who has knowledge of the primary root of trust (i.e., primary encryption key PK 108) may provide one or more of the secondary roots of trust as vendor encryption keys (e.g., eVK_{A} 112 and/or eVK_{B} 113) associated with device 100. Further, in accordance with some implementations of the invention, one or more vendors (e.g., one or more CA vendors) of computing platforms (such as STBs) employing device 100 who have knowledge of the primary root of trust (i.e., primary encryption key PK 108) may provide one or more of the secondary roots of trust or vendor encryption keys (e.g., eVK_{A} 112 and/or eVK_{B} 113) associated with device 100.

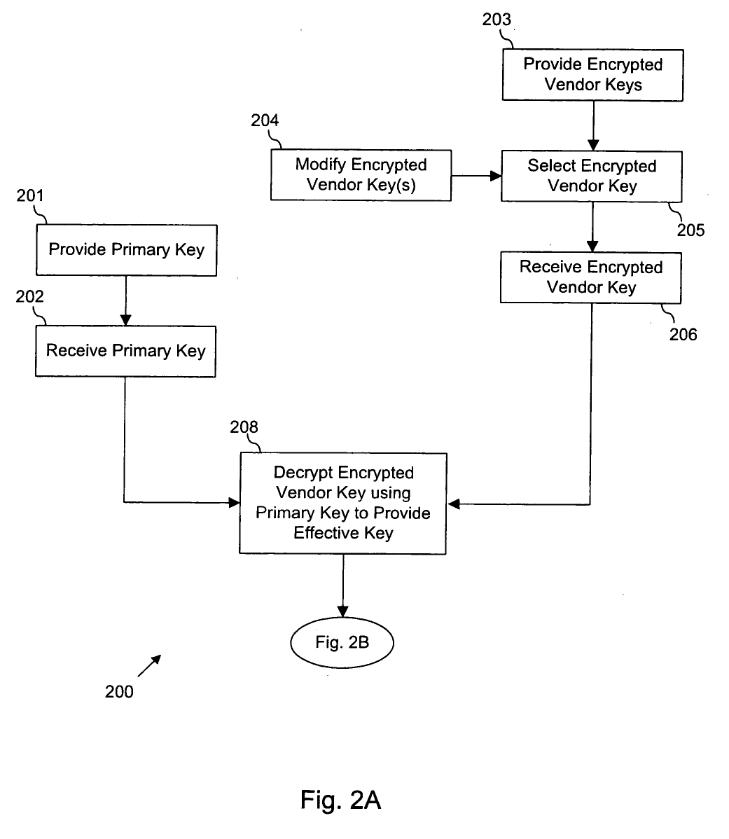

FIGS. 2A and 2B are flow charts illustrating a process 200 for protecting independent vendor encryption keys with a common primary encryption key in accordance with some implementations of the invention. While, for ease of explanation, process 200 may be described with regard to device 100 of FIG. 1 the invention is not limited in this regard and other processes or schemes supported by appropriate devices in accordance with the claimed invention are possible.

In an embodiment, the ‘master key’ may refer to a key that is used for encrypting the ‘control key’ that is sent securely to each device 100 from the network. The control key is used for encrypting ‘control words’ (also known as content keys, which are used to encrypt the audio visual content). First, a master key is sent securely over the network to each device 100, encrypted with the unique vendor key that is present in device 100, as discussed below in more detail. Next, an encrypted control key is sent securely over the network, encrypted with the master key, such that the encrypted control key can only be decrypted within device 100. The control words are then sent securely over the network, encrypted with a control key to device 100 along with the encrypted content to enable device 100 to decrypt and decode the received audio visual content, as discussed below in more detail.

Process 200 may begin with the provision of a primary key [act 201] as the primary root of trust for the system. One way to implement act 201 may be to have a manufacturer of device 100 (e.g., a manufacturer of one or more ICs used in device 100) provide the primary encryption key associated with device 100 (e.g., that manufacturer may provide or “program” OTP 106 with PK 108).

Process 200 may continue with the receipt of the primary key [act 202]. In some implementations of the invention, act 202 may, for example, involve having CM 102 receive the primary key PK 108 from OTP 106. Those skilled in the art will recognize that act 202 may involve using memory control logic in CM 102 to retrieve primary key PK 108 from a particular storage location in OTP 106. Alternatively, CM 102 or processor cores 116 may use internal or external memory control logic (not shown) to retrieve the primary key in act 202.

Process 200 may continue with the provision of encrypted “vendor keys” [act 203] that are provided by the CA vendors which form the secondary root of trust for the system. In some implementations of the invention, act 203 may be undertaken by having a manufacturer of a computing platform (such as a STB) employing device 100 that has knowledge of primary encryption key PK 108 provide the two or more vendor encryption keys (e.g., eVK_{A} 112 and eVK_{B} 113) associated with device 100. In accordance with some other implementations of the invention, one or more vendors (e.g., one or more CA vendors) of computing platforms (such as STBs) employing device 100 that also have knowledge of primary encryption key PK 108 may undertake act 203 by providing one or more of the vendor encryption keys (e.g., eVK_{A} 112 and/or eVK_{B} 113) associated with device 100.

Process 200 may include the modification of encrypted vendor key(s) [act 204]. One way to do this is to have a vendor (such as a CA vendor) of a computing platform employing device 100 who has knowledge of the primary encryption key PK 108 access one or more of the vendor encryption keys stored in memory 110 in order to modify that key or keys. It should be noted that the term “modify” as used in process 200 and elsewhere herein is to be interpreted broadly to include modification, revocation and/or replacement of encrypted vendor keys. In accordance with some other implementations of the invention, a manufacturer of a computing platform employing device 100 (e.g., a manufacturer of a STB employing device 100) who also has knowledge of the primary encryption key PK 108 may undertake act 204 by accessing one or more of the vendor encryption keys stored in memory 110 in order to modify that key or keys.

Process 200 may continue with the selection of an encrypted vendor key [act 205]. In some implementations of the invention, act 205 may be undertaken by having CM 102 or processor cores 116 provide a selection signal to mechanism 114 instructing mechanism 114 to provide one of encrypted vendor keys eVK_{A} 112 or eVK_{B} 113 from memory 110. Process 200 may continue with the receipt of an encrypted vendor key [act 206]. Act 206 may be undertaken by having CM 102 receive the encrypted vendor key selected in act 204. In other words, mechanism 114 may provide the selected encrypted vendor key to CM 102 in act 206. Those skilled in the art may recognize that mechanism 114 may be any mechanism to select, access and/or retrieve information stored in memory 110.

In accordance with some implementations of the invention, separate instances of acts 204 and 206 may be associated with the separate, independent uses of device 100 by different vendors. In other words, one vendor associated with one of the encrypted vendor keys stored in memory 110 may use device 100 to provide a particular collection of services to a user while another vendor associated with another one of the encrypted vendor keys stored in memory 110 may use device 100 to convey another particular collection of services to a user. Services may, for example, include the delivery of encrypted content to device 100 via a broadcast delivery mechanism such as a CA scheme associated with a satellite, cable television or Internet Protocol Television (IPTV) broadcast scheme.

Process 200 may then continue with the decryption of the encrypted vendor key using the primary key to provide an effective key [act 208]. In some implementations of the invention, CL 104 may use the primary key provided in act 202 (e.g., PK 108) to decrypt the encrypted vendor key (e.g., one of eVK_{A} 112 or eVK_{B} 113) selected in act 204 and provided in act 206. For example, CL 104 may employ well known cryptographic techniques, such as the RSA algorithm, to undertake act 208. However, as noted above, the invention is not limited to any particular encryption technique employed by CL 104 in undertaking act 208 or any decryption and/or encryption acts described herein.

Turning to FIG. 2B, process 200 may continue with the receipt of an encrypted master key Z [act 210] and the decryption of that using the effective key to provide the master key Z [act 212] in unencrypted form. In some implementations of the invention, act 210 may involve CM 102 receiving the encrypted master key Z and act 212 may involve having CL 104 use the effective key resulting from act 208 to decrypt the encrypted master key Z. CL 104 may do so in a manner similar to that described above with respect act 208. CL 104 may, for example, receive the encrypted master key from a CA vendor that provides the encrypted master key to device 100 where that CA vendor is associated with the vendor key selected in act 204. Although the invention is not limited in this regard, master key Z may comprise a key provided to device 100 in the context of a particular user of device 100 where that user is recognized as a subscriber of the CA vendor associated with a corresponding vendor key (e.g., either key eVK_{A} 112 or eVK_{B} 113). In other words, master key Z may be associated with that user's subscriber right to the services and/or content purveyed by that vendor using device 100.

Process 200 may continue with the receipt of an encrypted control key Y [act 214] and the decryption of that encrypted control key using the master key Z to provide control key Y [act 216] in unencrypted form. Similar to acts 210/212, one way to implement acts 214/216 is use CL 104 to decrypt the encrypted control key except in this case CL 104 uses the master key to decrypt the encrypted control key received in act 214. Process 200 may then conclude with the receipt of an encrypted control word X [act 218] and the decryption of that encrypted control word using the control key Y to provide the ladder A result (i.e., control word X in unencrypted form) [act 220]. Again, acts 218/220 may be carried out in a manner similar to that for acts 210/212 and 214/216. Although the invention is not limited in this regard, control key Y may comprise a key provided to device 100 to allow decryption of the control word where that control word determines, for example, what services and/or content a user of device 100 has access to when using device 100.

In accordance with some implementations of the invention, acts 202-220 may be described as one key ladder (e.g., key ladder “A”) having a primary root of trust in the form of a common primary encryption key (e.g., the primary key PK 108) and a secondary root of trust in the form of an independent vendor key (e.g., one of the vendor keys encrypted as eVK_{A} 112 or eVK_{B} 113). Key ladder A thus results in the generation of a decrypted control word associated with a first particular vendor.

Returning to acts 205-206, if acts 205/206 involve the selection and receipt of one encrypted vendor key (e.g., one of eVK_{A} 112 or eVK_{B} 113) associated with one vendor and acts 202-220 overall comprise one key ladder that uses, at least in part, the unencrypted form of that vendor key to generate an unencrypted control word associated with that vendor, then, in accordance with some implementations of the invention, if acts 204/206 involve the selection and receipt of another encrypted vendor key (e.g., the other one of eVK_{A} 112 or eVK_{B} 113) another key ladder comprising acts 202, 205-208 and 224-232 may use, at least in part, that other unencrypted vendor key to generate an unencrypted control word associated with that other vendor.

Thus, acts 202, 205-208 and 224-232 may be similar to acts 202-220 except that a different vendor's vendor key may be used, in conjunction with the same primary key (from act 202), to provide in act 208 a different effective key. That effective key may then be used to decrypt a different master key (Z′) in act 224 that may, in turn, be used to decrypt a different control key (Y′) in act 228 which, finally, may be used to decrypt a different control word (X′) in act 232 resulting in the generation of a decrypted control word associated with that different vendor. Thus, in accordance with some implementations of the invention, acts 202, 205-208 and 224-232 may be described as another key ladder (e.g., key ladder “B”) having a primary root of trust in the form of the common primary encryption key (e.g., primary key PK 108) and a secondary root of trust in the form of another independent vendor key (e.g., the other one of eVK_{A} 112 or eVK_{B} 113). Key ladder B thus results in the generation of a decrypted control word associated with a different selected vendor key.

Further, in accordance with some implementations of the invention, the two secondary roots of trust associated with device 100 and process 200 (e.g., one derived from decrypting eVK_{A} 112 and the other one from eVK_{B} 113) may comprise independent secret encryption keys each associated with a different vendor of device 100 and each used in conjunction with a common primary root of trust (e.g., primary key PK 108) to provide separate key ladders where that primary root of trust also comprises a secret encryption key. Thus, each instance of an individual pair of keys comprising one of the vendor keys and the primary key may comprise a separate asymmetric secret encryption key pair. The invention is not, however, limited to only two secondary roots of trust. Thus, in other implementations of the invention, for example, memory 110 may hold three or more encrypted vendor encryption keys and hence process 200 may be expanded to include additional key ladders similar to the key ladders comprising, respectively, acts 202, 205-208 and 224-232 and acts 202-220.

The acts shown in FIGS. 2A/B need not be implemented in the order shown; nor do all of the acts necessarily need to be performed. For example, for any given vendor key associated with a given CA vendor, a key ladder corresponding to acts 202, 205-208 and 224-232 may be implemented or a key ladder corresponding to acts 202-220 may be implemented. Also, those acts that are not dependent on other acts may be performed in parallel with the other acts. In addition some acts may be undertaken before other acts. For example, acts 205/206 of process 200 may be undertaken prior to act 202. In addition, some acts of process 200, such as act 204, need not be undertaken. Further, at least some of the acts in this figure may be implemented as instructions, or groups of instructions, implemented in a machine-readable medium.

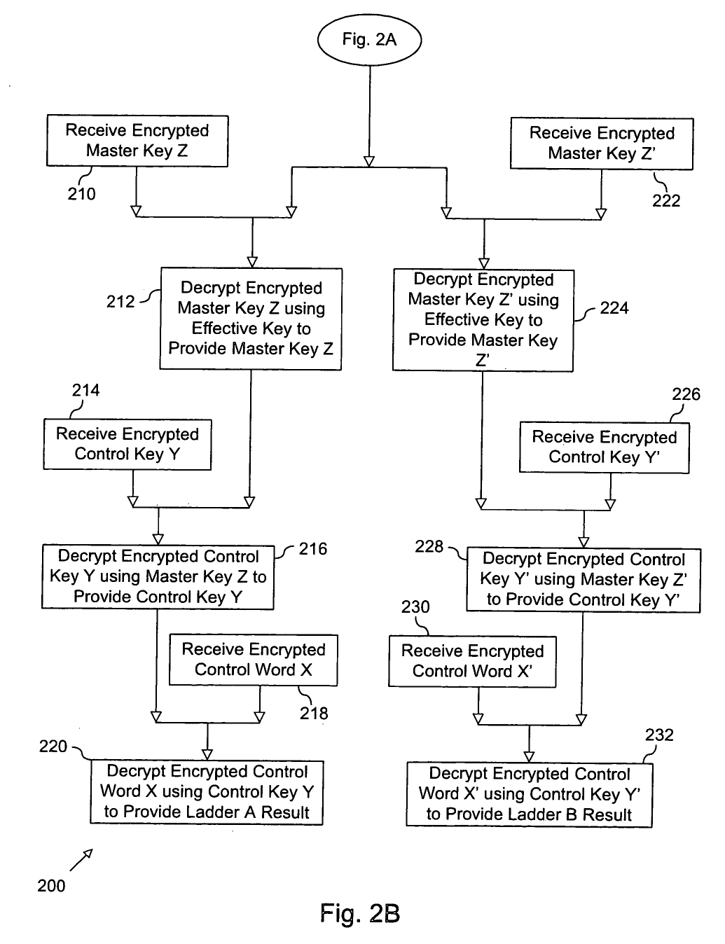

FIG. 3 illustrates an example system 300 according to some implementations of the invention. System 300 includes a media processor 302 coupled to a display controller 304, a cryptographic module 306, storage media 307 and a communications pathway 308. System 300 also includes memory 310 (e.g., dynamic random access memory (DRAM), static random access memory (SRAM), non-volatile memory such as flash memory, etc.) coupled to pathway 308, a display 312 coupled to controller 304, and an input/output (I/O) controller 314 coupled to pathway 308. In addition, system 300 includes wireless transmitter circuitry and wireless receiver circuitry 316 coupled to I/O controller 314 and an antenna 318 (e.g., dipole antenna, narrowband Meander Line Antenna (MLA), wideband MLA, inverted “F” antenna, planar inverted “F” antenna, Goubau antenna, Patch antenna, etc.) coupled to circuitry 316.

System 300 may be any system suitable for protecting independent vendor encryption keys with a common primary encryption key in accordance with some implementations of the invention as will be described in greater detail below. Moreover, system 300 may assume a variety of physical implementations. For example, system 300 may be implemented in a set-top box (STB), a personal computer (PC), a networked PC, a handheld computing platform (e.g., a personal digital assistant (PDA)), a cellular telephone handset, etc. In addition, while all components of system 300 may be implemented within a single device, such as a system-on-a-chip (SOC) integrated circuit (IC), components of system 300 may also be distributed across multiple ICs or devices. For example, media processor 302, module 306, storage 307, pathway 308, memory 310, controller 314, circuitry 316 and antenna 318 may be implemented, in part, as multiple ICs contained within a single computing platform, such as a STB to name one example, while display controller 304 may be implemented in a separate device such as display 312 coupled to media processor 302. Clearly, many such permutations are possible consistent with the functionality of system 300 as described herein.

Media processor 302 may comprise special purpose or general purpose processor core (s) including any control and/or processing logic in the form of hardware, software and/or firmware, capable of processing audio and/or image and/or video data and of providing display controller 304 with image and/or video data. Processor 302 may also utilize cryptographic module 106 to encrypt or decrypt cipher keys, and/or data/instructions such as control words, and may provide encrypted or decrypted keys, data and/or software instructions such as control words to memory 310 and/or storage 307. Those skilled in the art will recognize that processor 302 may also include control logic for controlling access to storage media 307 and/or memory 310. Moreover, while FIG. 3 shows cryptographic module 306 as a distinct device the invention is not limited in this regard and, for example, the functionality of cryptographic module 306 may be implemented in media processor 302.

Processor 302 may further be capable of performing any of a number of additional tasks that support protecting independent vendor encryption keys with a common primary encryption key. These tasks may include, for example, although the invention is not limited in this regard, obtaining encrypted keys and/or control words from devices external to system 300 by, for example, downloading such encrypted keys and/or control words via antenna 318, transmitter and receiver circuitry 316 and I/O controller 314. Those skilled in the art will recognize that processor 302 may undertake other support tasks such as, initializing and/or configuring registers within module 306 or controller 304, interrupt servicing, etc. In addition, although the invention is not limited in this regard, processor 302 may include more than one processor core. While FIG. 3 may be interpreted as showing processor 302 and controller 304 as distinct devices, the invention is not limited in this regard and those of skill in the art will recognize that media processor 302 and display controller 304 and possibly additional components of system 300 may be implemented within a single IC.

Cryptographic module 306 may provide the functionality of CM 102 and/or cipher logic 104 of device 100 as described above including the ability to perform one or more of the acts of process 200. In addition, either storage 307 or memory 310 may provide the functionality of memory 110 of device 100 including the ability to store and/or select from and/or provide two or more encrypted vendor keys. Further, processor 302 may provide the functionality of processor cores 116 of device 100. Finally, the functionality of OTP 106, namely to store the primary key PK, may be provided by or associated with cryptographic module 306 or processor 302.

Display controller 304 may comprise any processing logic in the form of hardware, software, and/or firmware, capable of converting graphics or image data supplied by media processor 302 into a format suitable for driving display 312 (i.e., display-specific data). For example, while the invention is not limited in this regard, processor 304 may provide graphics and/or image and/or video data to controller 304 in a specific color format, for example in a compressed red-green-blue (RGB) pixel format, and controller 304 may process that RGB data by generating, for example, corresponding liquid crystal display (LCD) drive data levels, etc. In addition, the invention is not limited to a particular type of display 312. Thus display 312 may be any type of display such as a LCD display, or an electroluminescent (EL) display, to name a few examples. For example, display 312 may be a flat panel LCD television.

Bus or communications pathway(s) 308 may comprise any mechanism for conveying information (e.g., keys encrypted or otherwise, etc.) between or amongst any of the elements of system 300. For example, although the invention is not limited in this regard, communications pathway(s) 308 may comprise a multipurpose bus capable of conveying, for example, encrypted keys to processor 302 or to CM 306. Alternatively, pathway(s) 308 may comprise a wireless communications pathway.

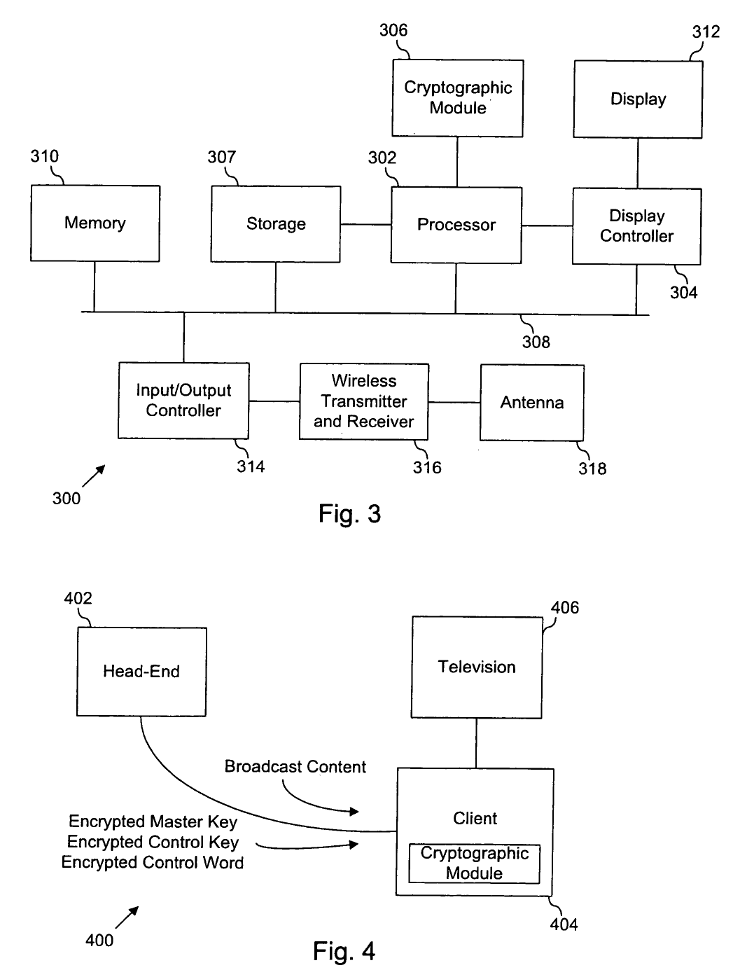

FIG. 4 illustrates another example system 400 according to some implementations of the invention. System 400 includes a head-end 402 coupled to a client 404 and a television coupled to client 404. Head-end 402 may comprise any form of content distribution infrastructure associated with, for example, a wired broadcast service provider (e.g., a cable service provider) or a wireless broadcast service provider (e.g., a satellite service provider) capable of providing broadcast services and/or content to client 404. Head-end 402 may also be capable of implementing portions of process 200 by conveying encrypted keys and/or words such as encrypted master and control keys and/or encrypted control words to client 404. The invention is not limited, however, to any specific structures or technologies used by head-end 404 to convey services and/or content and/or encrypted keys and/or control words to client 404. Television 406 may comprise any display technology capable of displaying content provided by head-end 402 to client 404.

Client 404 may, in accordance with some implementations of the invention, provide the functionality of device 100 and/or portions of system 300 such as module 306 or processor 302 consistent with the claimed invention and/or as described above. In some implementations of the invention, client 404 may comprise a STB. Further, client 404 may undertake one or more acts of process 200. Thus, for example, client 404 may use an internal cryptographic module similar to CM 102 and keys stored in internal storage technology similar to OTP 106 and/or memory 110, in conjunction with encrypted keys and encrypted control words supplied by head-end 402 to implement at least portions of process 200.

In accordance with some implementations of the invention a plurality of CA vendors, each having an associated encrypted vendor key stored in client 404, and each providing and/or implementing an instance of a head-end such as head-end 402, may utilize system 400 to control access by client 404 to services and/or content provided by the respective head-ends associated with those vendors. Thus, in accordance with some implementations of the invention, a single client 404 may be provided that enables process 200 to be implemented with respect to two or more independent CA vendors such that a single client 404 may support multiple independent secondary roots of trust (e.g., encrypted vendor keys) each originating with one of multiple CA vendors while maintaining a primary root of trust (e.g., the primary key) originating with the manufacturer of at least portions of client 404 (such as device 100) and stored in client 404.

While the foregoing description of one or more instantiations consistent with the claimed invention provides illustration and description of the invention it is not intended to be exhaustive or to limit the scope of the invention to the particular implementations disclosed. Clearly, modifications and variations are possible in light of the above teachings or may be acquired from practice of various implementations of the invention. For example, with respect to process 200, the content words decrypted in acts 220/232 can be any arbitrary data such as a list of subscriber content permissions/rights (e.g., list of cable television channels available to a subscriber/user of systems 300/400) or other data such as algorithm parameters. Clearly, many other implementations may be employed to enable protection of independent vendor encryption keys with a common primary encryption key consistent with the claimed invention.

In accordance with some implementations of the invention, apparatus/devices, systems and methods are described herein that enable one common primary root of trust (e.g., the primary encryption key) from which multiple secondary roots of trust (e.g., the CA vendor encryption keys) can be generated thus ensuring isolation of the independent vendor keys from each other. Thus, these independent vendor keys may be stored in encrypted form and then decrypted, using process 200, at initialization of the client device (e.g., client 404) or as needed. In other implementations of the invention, the vendor keys may be kept encrypted external to the device where they may then be read into the device, decrypted with the primary key and loaded into volatile memory locations on the device. In this way a single device design may be utilized by multiple CA vendors because the secondary roots of trust (i.e., the vendor keys) may be programmed and/or provided at a later stage in the distribution process. Further, the secondary roots of trust may later be modified, revoked or replaced by any entity possessing knowledge of the primary root of trust (i.e., the primary key). Hence, in this manner, updated keys may be used to retarget a device (such as client 404) from one CA vendor to another CA vendor. Finally, apparatus, systems and/or methods in accordance with some implementations of the invention may provide an additional layer of encryption protection to key ladders.

No device, element, act, data type, instruction etc. set forth in the description of the present invention should be construed as critical or essential to the invention unless explicitly described as such. Also, as used herein, the article “a” is intended to include one or more items. Moreover, when terms or phrases such as “coupled” or “responsive” or “in communication with” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
selecting a first encrypted secondary key from a plurality of encrypted secondary keys, each encrypted secondary key of the plurality of encrypted secondary keys associated with a separate one of a plurality of conditional access vendors;
receiving a primary key; and
decrypting the first encrypted secondary key using the primary key to provide a first unencrypted secondary key.

2. The method of claim 1, wherein the primary root of trust and each secondary key comprise an asymmetric secret key pair.

3. The method of claim 1, wherein the first unencrypted secondary key comprises a first effective key, the method further comprising:
receiving an encrypted master key;
decrypting the encrypted master key using a first effective key to provide a master key;
receiving an encrypted control key;
decrypting the encrypted control key using the master key to provide a control key;
receiving an encrypted control word; and
decrypting the encrypted control word using the control key to provide a control word.

4. The method of claim 3, wherein the encrypted master key and the encrypted control key are provided by a first conditional access vendor of the plurality of conditional access vendors.

5. The method of claim 3, wherein the first conditional access vendor is one of a cable television broadcast vendor, a satellite television broadcast vendor, or an internet protocol television broadcast vendor.

6. The method of claim 1, further comprising:
selecting a second encrypted secondary key from the plurality of encrypted secondary keys, the second encrypted secondary key associated with a second conditional access vendor; and
decrypting the second encrypted secondary key using the primary key to provide a second unencrypted secondary key.

7. The method of claim 6, further comprising
receiving a second encrypted control word, the second encrypted control word provided by the second conditional access vendor; and
using the second unencrypted secondary key to decrypt the second encrypted control word.

8. The method of claim 1, further comprising:
modifying an encrypted secondary key of the plurality of encrypted secondary keys.

9. The method of claim 8, wherein modifying an encrypted secondary key of the plurality of encrypted secondary keys comprises one of modifying, replacing or revoking an encrypted secondary key of the plurality of encrypted secondary keys.

10. An apparatus comprising:
memory to store a plurality of encrypted vendor keys;
memory to store a primary key; and
cipher logic to provide an effective key by using the primary key to decrypt an encrypted vendor key of the plurality of encrypted vendor keys.

11. The apparatus of claim 10, the cipher logic further to provide another effective key by using the primary key to decrypt another encrypted vendor key of the plurality of encrypted vendor keys.

12. The apparatus of claim 11, wherein the effective key and the another effective key comprise encryption keys associated with different conditional access vendors.

13. The apparatus of claim 10, the cipher logic further to use the effective key to decrypt a master key, to use the master key to decrypt a control key, and to use the control key to decrypt a control word.

14. The apparatus of claim 10, wherein the primary key is provided by a manufacturer of the cipher logic.

15. A system comprising:
a head-end content source; and
a client coupled to the head-end content source, the client to receive an encrypted master encryption key from the head-end, the client including:
memory to store a plurality of encrypted vendor encryption keys;
memory to store a primary encryption key; and
cipher logic to use the primary encryption key to decrypt an encrypted vendor encryption key of the plurality of encrypted vendor encryption keys to provide an effective encryption key, and to use the effective encryption key to decrypt the encrypted master encryption key to provide a master encryption key.

16. The system of claim 15, the cipher logic further to use the primary encryption key to decrypt another encrypted vendor encryption key of the plurality of encrypted vendor encryption keys to provide another effective encryption key.

17. The system of claim 16, wherein the effective encryption key and the another effective encryption key comprise encryption keys associated with different conditional access vendors.

18. The system of claim 15, the cipher logic further to use the master encryption key to decrypt a control encryption key, and to use the control encryption key to decrypt a control word.

19. The system of claim 15, wherein the memory to store a primary key comprises one time programmable memory.

20. The system of claim 15, wherein the primary key is provided by one of a manufacturer of the cipher logic or a manufacturer of the client.

21. The system of claim 15, wherein the plurality of encrypted vendor keys are provided by one of a manufacturer of the cipher logic or two or more conditional access vendors associated with the plurality of encrypted vendor keys.
